(19) United States
(12) Patent Application Publication
(10) Pub. No.: US 2011/0285492 A1
(43) Pub. Date: Nov. 24, 2011

(54) FERRITE CORE COIL

(75) Inventors: Ching-Shun Wang, TamShui (TW); Chun-Hua Hsia, TamShui (TW); Yuan-Bin Tang, TamShui (TW)

(73) Assignee: Advanced Connection Technology, Inc., TamShui (TW)

(21) Appl. No.: 12/834,967

(22) Filed: Jul. 13, 2010

(30) Foreign Application Priority Data
May 19, 2010 (TW) 99209414

(51) Int. Cl. H01F 27/30

(52) U.S. Cl. 336/198

(57) ABSTRACT

A ferrite core coil is provided, which includes a ferrite core element, at least a flexible substrate, and a plurality of first conductors disposed at an interval on the flexible substrate. The ferrite core element has at least a winding area, and the flexible substrate wraps a surface of the winding area of the ferrite core element. Furthermore, two ends of each first conductor respectively have a first contact and a second contact. In this manner, when the first contact of the first conductor and the second contact of the adjacent first conductor are connected electrically, a coil circumscribing the ferrite core element is formed. The winding process is thus greatly simplified, automatic fabrication of the ferrite core coil is facilitated, and the lithography process can be used to fabricate the first conductors on the flexible substrate, resulting in a small sized ferrite core coil.

### CROSS-REFERENCES TO RELATED APPLICATIONS

This non-provisional application claims priority under 35 U.S.C. §119(a) on Patent Application No. 99209414 filed in Taiwan, R.O.C. on 2010 May 19 the entire contents of which are hereby incorporated by reference.

### BACKGROUND OF THE INVENTION

1. Field of Invention

The present invention relates to a ferrite core coil, and more particularly to a ferrite core coil having conductors disposed on a flexible substrate and the flexible substrate directly wrapping a ferrite core.

2. Related Art

Ferrite core coils are commonly used in the fabrication of inductors, transformers, common mode chokes, and other electronic elements or devices. In a conventional process of fabricating the ferrite core coil, a conductor with an insulator coating (e.g., enameled wire), is wound on a certain winding area of a ferrite core to reduce leakage inductance and flux loss. In most circumstances, a closed (ring) ferrite core must be adopted to solve the problem of the aforementioned leakage inductance and flux loss while avoiding the external magnetic line of force entering the ferrite core and causing interference. However, this method also greatly increases the difficulty in winding.

In order to solve the problem of difficulty in winding of the closed ferrite core, a combined ferrite core is provided in the prior art. The ferrite core is divided into two or more sections. After winding, the sections of the ferrite core are bonded. However, the enameled wire must be wound on the winding area of the ferrite core element manually or by machines, increasing the processing time and furthermore reducing the inductance of the entire ferrite core coil due to the nonhomogeneous surface of the ferrite core formed by bonding.

Moreover, the conventional winding machine uses enameled wire of certain diameters. Thin enameled wires may break easily in winding, so the size of the ferrite core coil is restricted by the diameter of the enameled wire, and cannot be further reduced.

Therefore, the conventional ferrite core coil is deficient in that it is difficult to wind and the size cannot be reduced, requiring a solution by those skilled in the art.

### SUMMARY OF THE INVENTION

In order to solve these problems in the prior art, a ferrite core coil is provided, which includes a ferrite core element, at least a flexible substrate, and a plurality of first conductors disposed at an interval on the flexible substrate. The ferrite core element has at least a winding area, and the flexible substrate wraps a surface of the winding area of the ferrite core element. Furthermore, two ends of each first conductor respectively have a first contact and a second contact. In this manner, when the first contact of the first conductor and the second contact of the adjacent first conductor are connected electrically, a coil circumscribing the ferrite core element is formed.

The method for connecting the first contacts and the second contacts electrically includes an indirect or a direct manner. According to the direct manner, the first conductors are arranged obliquely on the flexible substrate, and when the flexible substrate wraps the winding area, the first contact of the first conductor and the second contact of the adjacent first conductor are connected electrically by means of direct contact or solder reflow. In this manner, the first conductor disposed on the flexible substrate and circumscribing the winding area of the ferrite core element forms a coil structure as a whole.

When the ferrite core coil is connected to a printed circuit board (PCB) by a surface mount technology (SMT), the indirect electrical connection method may be used. The indirect manner refers to the fact that when the flexible substrate wraps the winding area of the ferrite core element, the first contact of the first conductor and the second contact of the adjacent first conductor are not connected electrically but connected by a connecting portion of a plurality of first conductors disposed on the PCB and coupled to the flexible substrate. The connecting portion has a plurality of first pins and a plurality of second pins, in which the plurality of first pins is respectively connected electrically to the first contacts of the plurality of first conductors, and the plurality of second pins is respectively connected electrically to the second contacts of the plurality of first conductors. Then, a plurality of second conductors arranged at an interval and oblique to the first conductors is used, such that two ends of each second conductor are respectively connected electrically to the first pin and the second pin. In this manner, the first conductor is conducted electrically with the adjacent first conductor by means of the connecting portion and the bridging of the second conductor, forming a coil structure circumscribing the ferrite core element.

The present invention thus alleviates greatly the inconvenience in the conventional ferrite core winding method, facilitating automatic fabrication of the ferrite core coil. Moreover, the lithography process can be used to fabricate the first conductors on the flexible substrate, and thus the size of the ferrite core coil is further reduced. The embodiments and efficacy of the present invention are described in the following with the accompanying drawings.

### BRIEF DESCRIPTION OF THE DRAWINGS

The present invention will become more fully understood from the detailed description given herein below for illustration only, and thus not limitative of the present invention, and wherein:

FIG. 1 is an exploded view of a first embodiment of the present invention;

FIG. 2 is a three-dimensional view of the first embodiment of the present invention;

FIG. 3 is a schematic view of a flexible substrate according to the first embodiment of the present invention;

FIG. 4 is a partial enlarged view of first contacts and second contacts according to the first embodiment of the present invention;

FIG. 5 is a sectional view taken along Line A-A of the present invention;

FIG. 6 is a schematic view of a connecting portion according to the first embodiment of the present invention;

FIG. 7 is a schematic view of a flexible substrate according to a second embodiment of the present invention;

FIG. 8 is a partial enlarged view of first contacts and second contacts according to the second embodiment of the present invention;

FIG. 9 is a sectional view taken along Line B-B of the present invention;

FIG. 10 is a schematic view of a connecting portion according to the second embodiment of the present invention;

FIG. 11 is an exploded view of a third embodiment of the present invention;

FIG. 12 is a three-dimensional view of the third embodiment of the present invention;

FIG. 13 is a schematic view of a flexible substrate according to the third embodiment of the present invention;

FIG. 14 is a partial enlarged view of first contacts and second contacts according to the third embodiment of the present invention;

FIG. 15 is a sectional view taken along Line C-C of the present invention;

FIG. 16 is an exploded view of a fourth embodiment of the present invention;

FIG. 17 is a three-dimensional view of the fourth embodiment of the present invention;

FIG. 18 is a schematic view of a connecting portion according to the fourth embodiment of the present invention;

FIG. 19 is a schematic view of a fifth embodiment of the present invention;

FIG. 20 is a three-dimensional view of a sixth embodiment of the present invention;

FIG. 21 is a schematic view of a connecting portion according to the sixth embodiment of the present invention;

FIG. 22 is a schematic enlarged view of the connecting portion according to the sixth embodiment of the present invention;

FIG. 23 is an exploded view of a seventh embodiment of the present invention; and

FIG. 24 is a three-dimensional view of the seventh embodiment of the present invention.

### DETAILED DESCRIPTION OF THE INVENTION

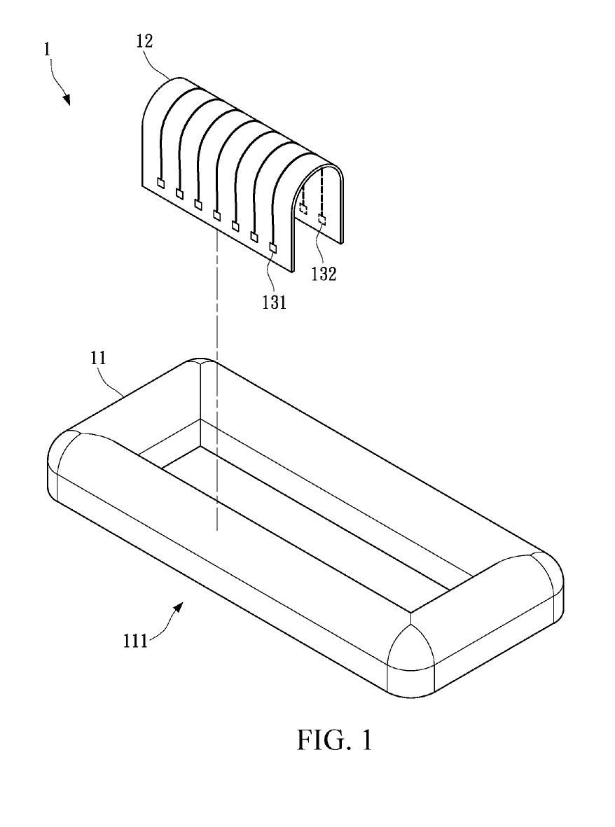

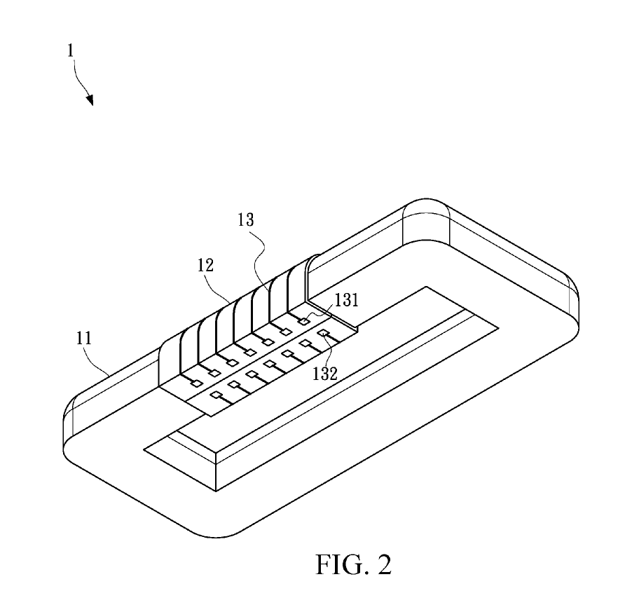

FIGS. 1 and 2 are respectively an exploded view and a three-dimensional view according to a first embodiment of the present invention. This embodiment includes a ferrite core element 11, at least a flexible substrate 12, and a plurality of first conductors 13 disposed at an interval on the flexible substrate. The ferrite core element 11 has at least a winding area 111, and the flexible substrate 12 wraps a surface of the winding area 111 of the ferrite core element 11. Furthermore, two ends of each first conductor 13 respectively have a first contact 131 and a second contact 132. In this manner, when the first contact 131 of the first conductor 13 and the second contact 132 of the adjacent first conductor 13 are connected electrically, a coil circumscribing the ferrite core element 11 is formed. When the first contacts 131 of more first conductors 13 and the second contacts 132 of the adjacent first conductors 13 are connected electrically, a coil structure with more turns is formed.

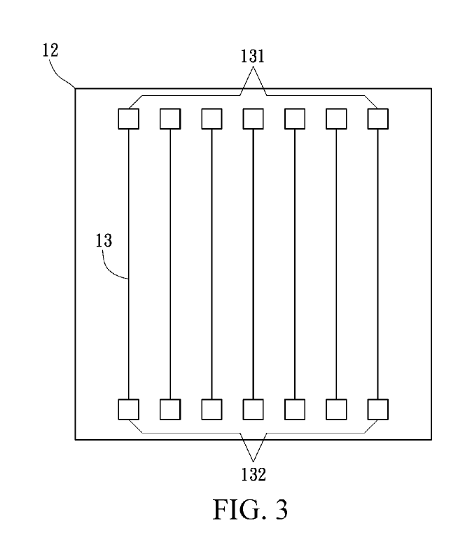

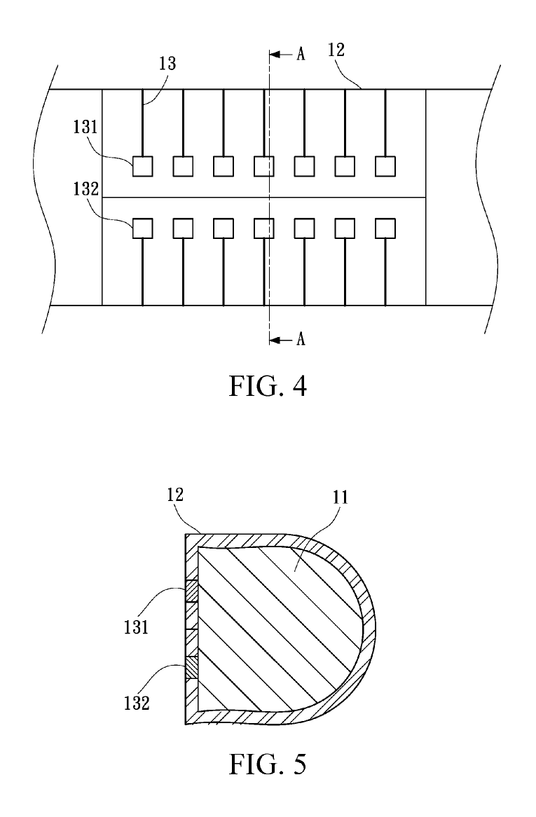

FIG. 3 is a schematic view of the flexible substrate according to the first embodiment of the present invention. In this embodiment, a plurality of first conductors 13 is disposed in parallel and at an interval on the flexible substrate 12. Therefore, when the flexible substrate 12 wraps the surface of the winding area 111, the first contact 131 and the second contact 132 of each first conductor 13 are opposite to each other and spaced by a certain distance, as shown in FIG. 4. Furthermore, as shown in FIG. 5, one side of the ferrite core element 11 of this embodiment is a plane, such that the first contact 131 and the second contact 132 are on the same plane, which facilitates the connection to the circuit outside. However, the ferrite core element 11 is not limited to have at least a plane at one side, and the geometric shape of the ferrite core element is determined according to demands on design and functions.

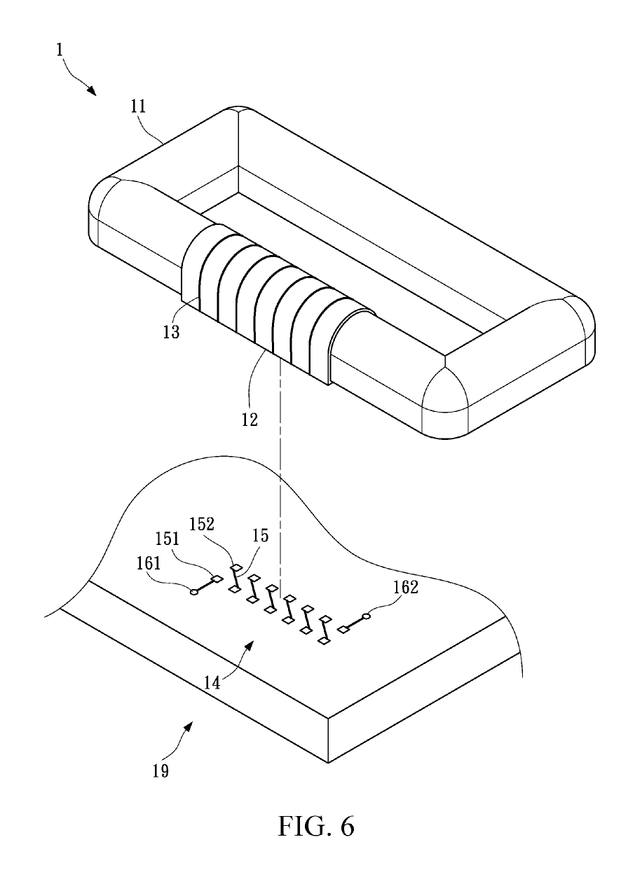

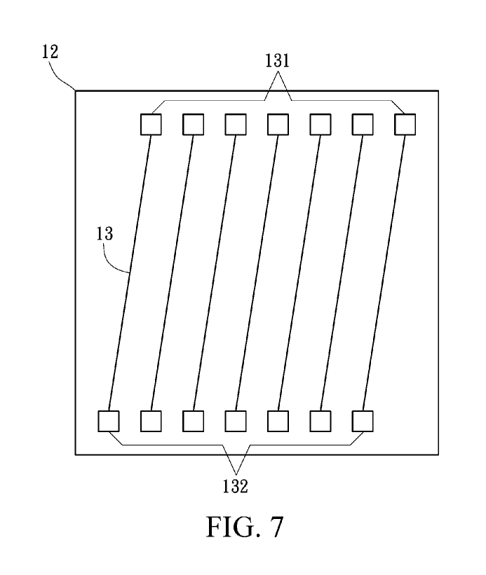

FIG. 6 is a schematic view (1) of a connecting portion according to the first embodiment of the present invention. In this embodiment, the first contact 131 of the first conductor 13 is indirectly connected electrically to the second contact 132 of the adjacent first conductor 13 through a connecting portion 14 on a PCB 19. The connecting portion 14 has a plurality of first pins 151 and a plurality of second pins 152. The plurality of first pins 151 is respectively connected electrically to the first contacts 131 of the plurality of first conductors 13. The plurality of second pins 152 is respectively connected electrically to the second contacts 132 of the plurality of first conductors 13. Then, a plurality of second conductors 15 arranged at an interval and oblique to the first conductors 13 is used, such that two ends of each second conductor 15 are respectively connected electrically to the first pin 151 and the second pin 152. In this manner, through the connecting portion 14 and the bridging of the second conductor 15, the first conductor 13 is electrically conducted with the adjacent first conductor 13 to form the coil structure circumscribing the ferrite core element 11. An electrical signal is input through a first signal contact 161 and output through a second signal contact 162, or vise versa. This embodiment is particularly suitable for inductor devices.

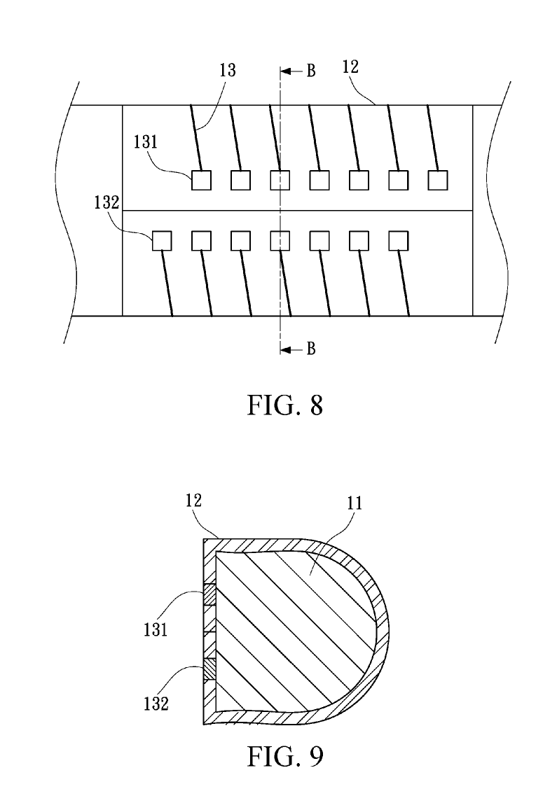

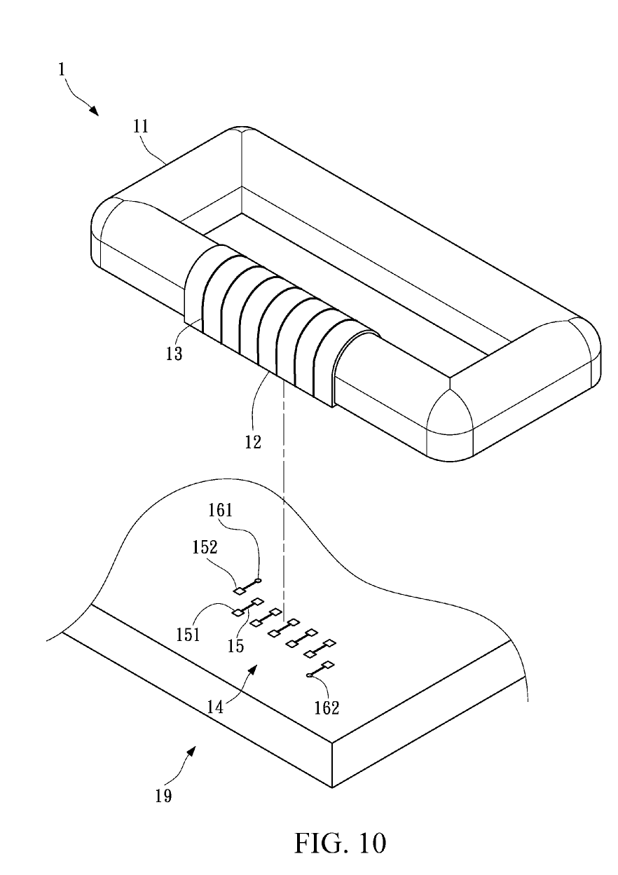

FIGS. 7 to 10 are respectively a schematic view of the flexible substrate, a partial enlarged view of the first contacts and the second contacts, a sectional view taken along Line B-B, and a schematic view of the connecting portion according to a second embodiment of the present invention. This embodiment differs from the first embodiment in that, the first conductors 13 of this embodiment, as shown in FIG. 7, are arranged obliquely on the flexible substrate 12, the plurality of second conductors 15, as shown in FIG. 10, is arranged in parallel and at an interval, and two ends of each second conductor 15 are respectively connected electrically to the first pin 151 and the second pin 152. In the indirect connecting method, through the connecting portion 14 and the bridging of the second conductor 15, the first conductor 13 is electrically conducted with the adjacent first conductor 13 to form the coil structure circumscribing the ferrite core element 11. The electrical signal is input through the first signal contact 161 and output through the second signal contact 162, or vise versa.

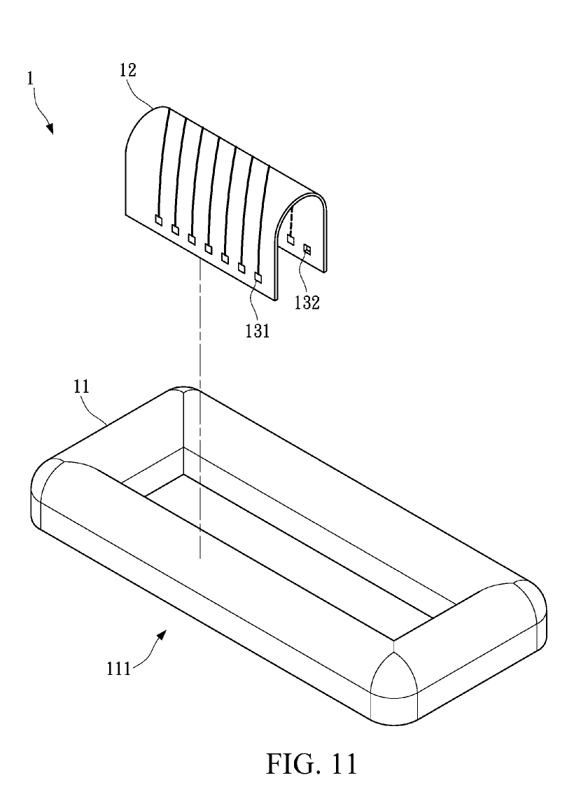

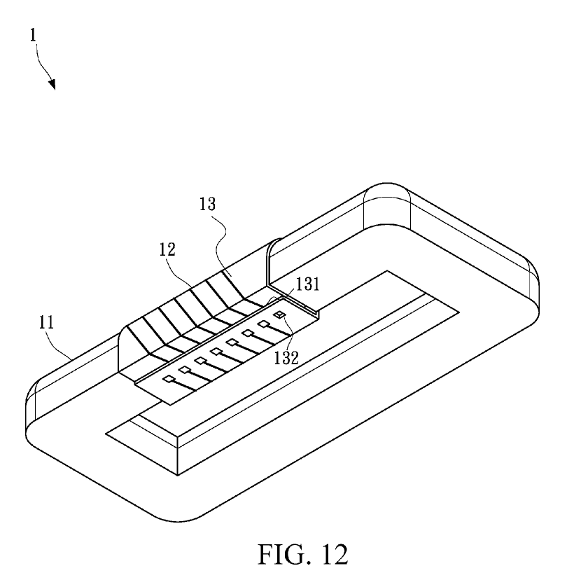

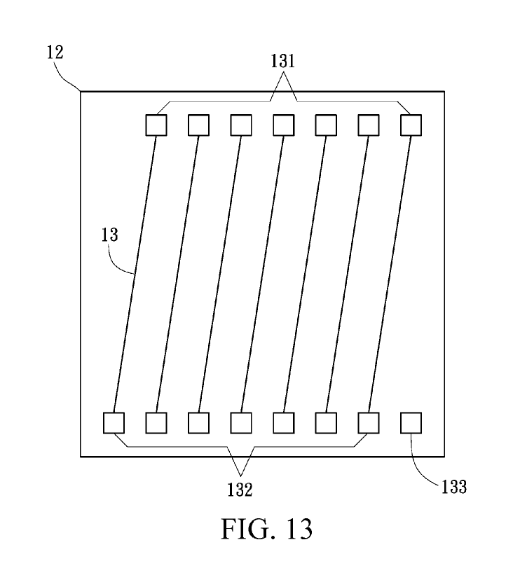

FIGS. 11 to 13 are respectively an exploded view, a three-dimensional view, and a schematic view of the flexible substrate according to a third embodiment of the present invention. In this embodiment, the plurality of first conductors 13, as shown in FIG. 13, is arranged obliquely on the flexible substrate 12. Therefore, when the flexible substrate 12 wraps the winding area 111 of the ferrite core element 11, the first contact 131 of the first conductor 13 and the second contact 132 of the adjacent first conductor 13 are connected electrically by means of direct contact or reflow.

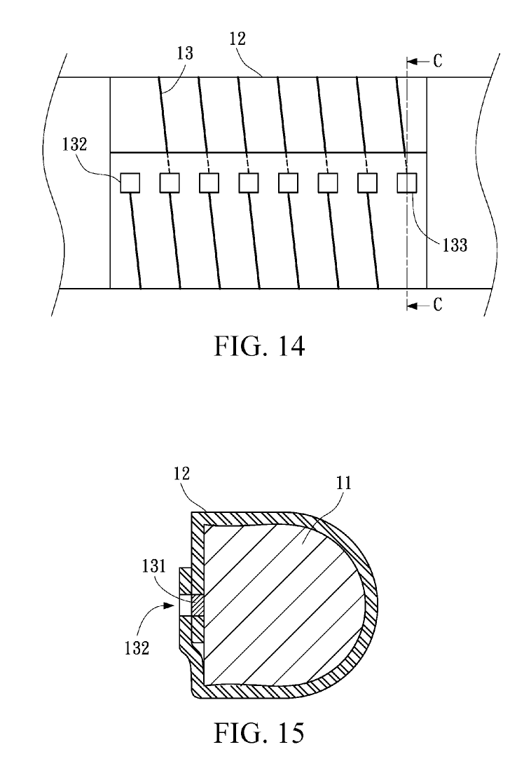

In view of the above, in this embodiment, an opening 133 is additionally disposed on the flexible substrate 12, as shown in FIGS. 14 and 15. When the flexible substrate 12 wraps the winding area 111, the first contact 131 under the opening 133 may be connected electrically to the outside via the opening 133.

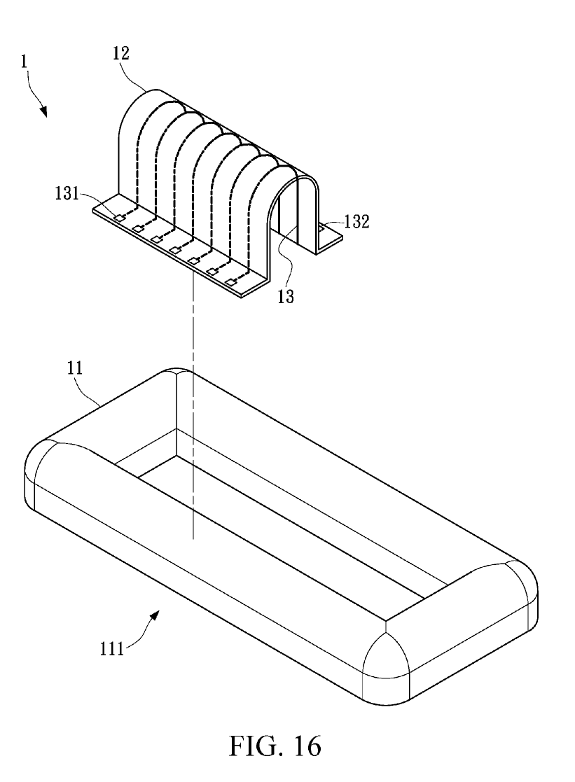

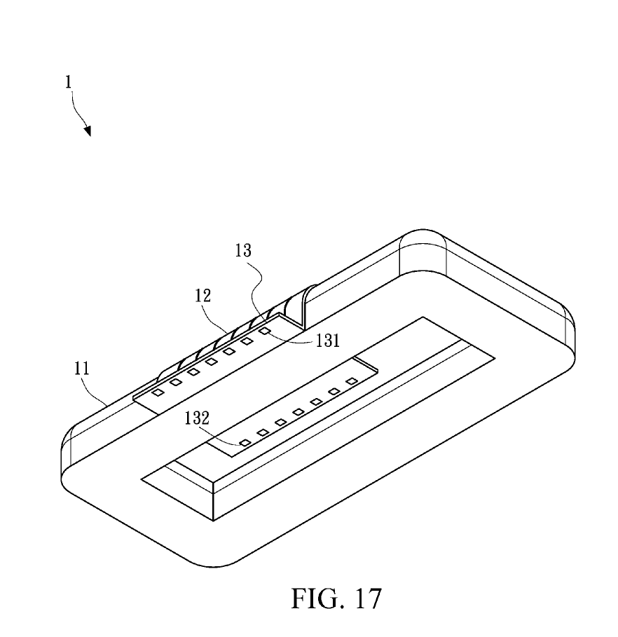

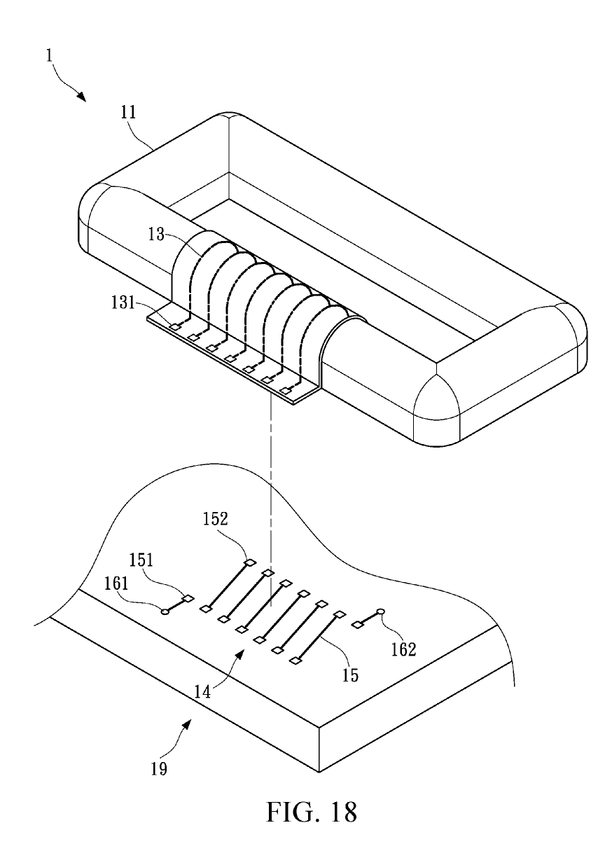

FIGS. 16 to 18 are respectively an exploded view, a three-dimensional view, and a schematic view of the connecting portion according to a fourth embodiment of the present invention. This embodiment differs from the first embodiment in that, when the flexible substrate 12 wraps the ferrite core element 11, two sides of the flexible substrate 12 are bent outwards, such that the plurality of first contacts 131 and the plurality of second contacts 132 are exposed to the outside rather than under the ferrite core element 11.

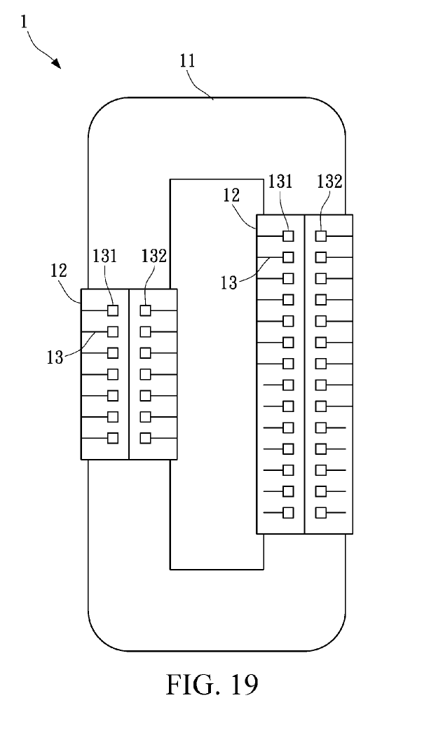

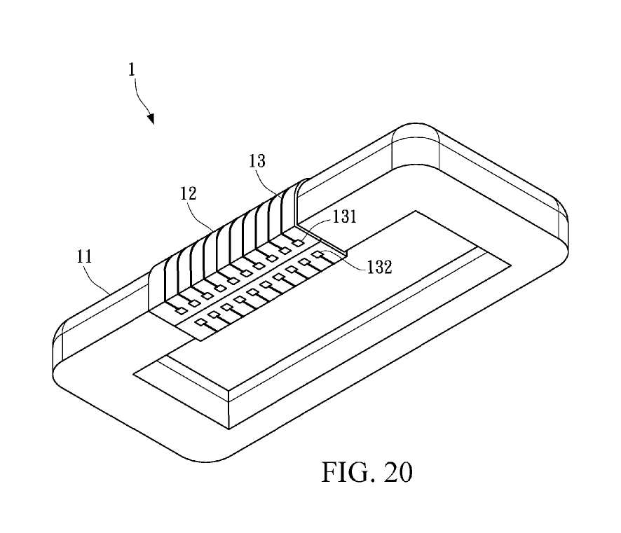

FIG. 19 is a schematic view of a fifth embodiment of the present invention. The ferrite core element 11 of this embodiment has two winding areas 111, and each winding area 111 respectively covers the flexible substrate 12 having a different number of the first conductors 13. This embodiment is particularly suitable for a transformer. When the two flexible substrates 12 have the same number of the first conductors 13, and the formed coil structures circumscribe in opposite directions, a common mode choke device is acquired.

FIG. 20 is a three-dimensional view of a sixth embodiment of the present invention. One side of the ferrite core element 11 of this embodiment is narrower than the other side, thereby effectively reducing the size of the ferrite core coil 1.

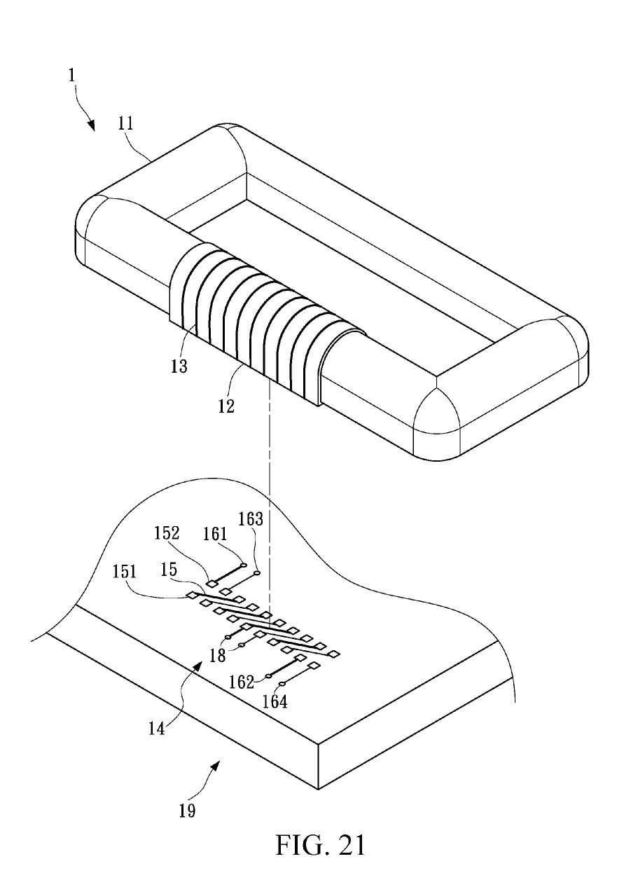

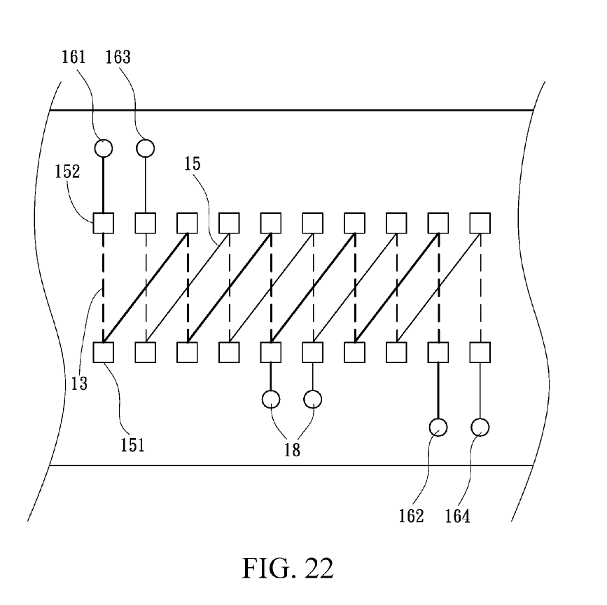

FIGS. 21 and 22 are respectively a schematic view of the connecting portion and a schematic enlarged view of the connecting portion according to the sixth embodiment of the present invention. By changing the wiring method of the second conductors 15 of the connecting portion 14, the plurality of first conductors 13 of this embodiment is divided into two winding portions. In one winding portion, the electrical signal is input through the first signal contact 161 and output through the second signal contact 162. In another winding portion, the electrical signal is input through a third signal contact 163 and output through a fourth signal contact 164. The dashed line in FIG. 22 indicates a relative relation between the first conductors 13 and the second conductors 15 when the ferrite core coil 1 and the connecting portion 14 of this embodiment are connected. Further, in this embodiment, a center tapping 18 is respectively disposed on the connecting portion 14 directed to the two winding portions.

In the above embodiment, the flexible substrate 12 adheres to and wraps the winding area 111 of the ferrite core element 11 with a self-adhesive (not shown).

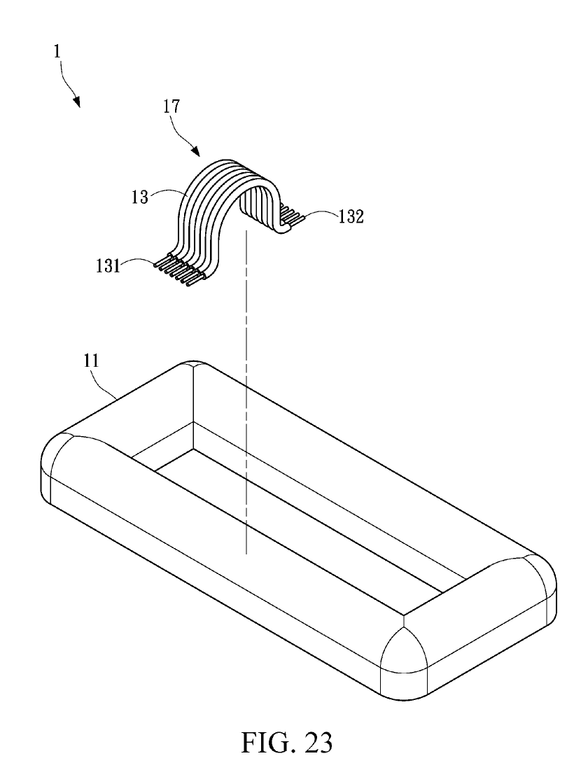

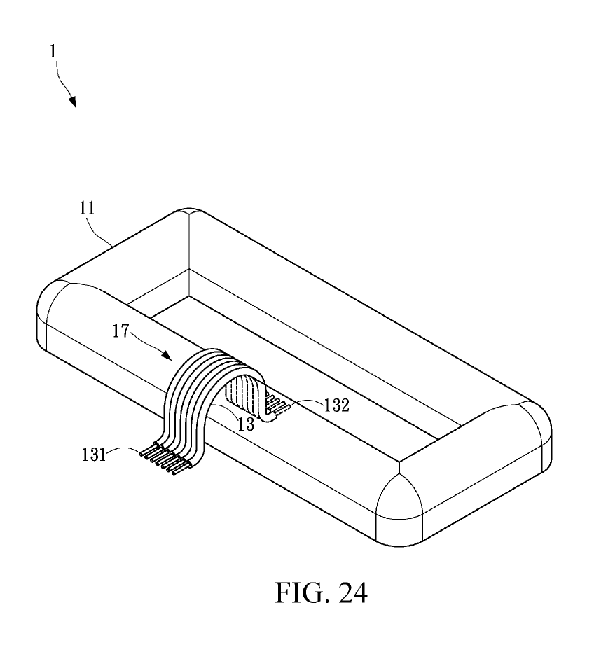

FIGS. 23 and 24 are respectively an exploded view and a three-dimensional view of a seventh embodiment of the present invention. This embodiment differs from the aforementioned embodiments in that a flexible cable 17 is used to circumscribe the ferrite core element 11. The cable 17 is composed of a plurality of first conductors 13. Two ends of each first conductor 13 respectively have a first contact 131 and a second contact 132.

Similar to the aforementioned embodiments, in this embodiment, the coil structure circumscribing the ferrite core element 11 is formed through the connection of the connecting portion 14 and the plurality of second conductors 15.

While the present invention has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A ferrite core coil, comprising:
a ferrite core element, having at least a winding area;
at least a flexible substrate, wrapping the winding area; and
a plurality of first conductors, disposed at an interval on the flexible substrate, wherein two ends of each first conductor respectively have a first contact and a second contact.

2. The ferrite core coil according to claim 1, further comprising:
a connecting portion, coupled to the first conductors on the flexible substrate, and having a plurality of first pins and a plurality of second pins, wherein the first pins are respectively connected electrically to the first contact, and the second pins are respectively connected electrically to the second contact.

3. The ferrite core coil according to claim 2, further comprising:
a plurality of second conductors, arranged at an interval and oblique to the first conductors, wherein two ends of each second conductor are respectively connected electrically to the first pin and the second pin.

4. The ferrite core coil according to claim 3, wherein the first and second conductors are divided into a plurality of winding portions, and the first and second conductors of each winding portion are connected in series to form a single electrical loop.

5. The ferrite core coil according to claim 4, wherein a number of the first conductors of at least one of the winding portions is different from that of the first conductors of the rest winding portions.

6. The ferrite core coil according to claim 4, wherein a number of the second conductors of at least one of the winding portions is different from that of the second conductors of the rest winding portions.

7. The ferrite core coil according to claim 2, further comprising:
a plurality of second conductors, arranged in parallel and at an interval, wherein two ends of each second conductor are respectively connected electrically to the first pin and the second pin, and furthermore, the first conductors are arranged obliquely on the flexible substrate.

8. The ferrite core coil according to claim 2, wherein the connecting portion has a center tapping.

9. The ferrite core coil according to claim 1, wherein the flexible substrate adheres to and wraps the winding area with a self-adhesive.

10. The ferrite core coil according to claim 1, wherein the first contact of at least one of the first conductors and the second contact of the adjacent first conductor are connected electrically.

11. A ferrite core coil, comprising:
a ferrite core element, having at least a winding area; and
a cable, wrapping the winding area, wherein the cable is composed of a plurality of first conductors, and two ends of each first conductor respectively have a first contact and a second contact.

12. The ferrite core coil according to claim 11, further comprising:
a connecting portion, coupled to the first conductors of the cable, and having a plurality of first pins and a plurality of second pins, wherein the first pins are respectively connected electrically to the first contact, and the second pins are respectively connected electrically to the second contact.

13. The ferrite core coil according to claim 12, further comprising:
a plurality of second conductors, arranged at an interval and oblique to the first conductors, wherein two ends of each second conductor are respectively connected electrically to the first pin and the second pin.
